(19) United States
(12) Patent Application Publication
(10) Pub. No.: US 2019/0053179 A1
(43) Pub. Date: Feb. 14, 2019

(54) DEVICE TO DEVICE SYNCHROINZATION FOR LIMITED BANDWIDTH UES

(71) Applicant: ZTE Corporation, Shenzhen (CN)

(72) Inventor: CAROLYN TAYLOR, Homewood, IL (US)

(21) Appl. No.: 15/672,722

(22) Filed: Aug. 9, 2017

(51) Int. Cl. H04W 56/00; H04W 64/00; H04W 88/04

(52) U.S. Cl. CPC H04W 56/0015; H04W 56/0025; H04W 4/005; H04W 88/04; H04W 76/023; H04W 64/003

(57) ABSTRACT

The synchronization procedure and selection of a synchronization source among multiple synchronization sources supporting 1 PRB limited bandwidth UE (e.g. NB-IoT). The selection of the synchronization source is determined by picking a synchronization source group (SSG) that is configured to perform a pre-selection of synchronization sources for the initial acquisition that is based on the following criterion: type synchronization source, synchronization timing, and proximity to synchronization source. In particular, the synchronization receiving UE would select a SSG in accordance with the criterion and select one of its synchronization sources, respectively. Once the synchronization source is determined the D2D synchronization signal can be transmitted accordingly.

### FIELD OF THE INVENTION

The present invention relates to methods for selection and reselection of a synchronization source among multiple synchronization sources supporting 1 physical resource block (PRB) limited bandwidth user equipment (UE), for example, narrowband Internet of Things (NB-IoT) for wireless communications.

### BACKGROUND

Devices with wireless communications capabilities, such as mobile telephones, handheld devices, devices embedded in laptop computers, Device-to-Device devices (D2D), wearables, NB-IoT and similar devices, will be referred to herein as User Equipment (UE).

Wireless communications is continuously evolving. There are many advanced technology equipment being introduced that can provide services that were not possible previously. This advanced technology equipment might include, for example, an Enhanced Node B (eNB) rather than a base station or other systems and devices that are more highly evolved than the equivalent equipment in a traditional wireless telecommunications system. Such advanced or next generation equipment may be referred to herein as High Speed Packet Access (HSPA) equipment and long-term evolution (LTE) equipment.

In traditional wireless telecommunications systems, transmission equipment in a base station transmits signals throughout a geographic region that is called a “cell”. For LTE and other advanced equipment, the region in which a UE can gain access to a wireless communications network might be referred to as a different name, for instance called a “hot spot”. The terminology for example “cell” will be used herein to refer to any geographic region in which a UE can gain access to a wireless communications network, regardless of the type of UE and regardless of whether the region is a traditional cell, a region served by LTE equipment such as an eNB, or some other region in which wireless communications services are available.

Heterogeneous networks (HetNets) consist of a mix of macrocells, remote radio heads, and low-power nodes such as picocells, femtocells, and relays

Leveraging network topology, increasing the proximity between the access network and the end-users, has the potential to provide the next significant performance leap in wireless networks, improving spatial spectrum reuse and enhancing indoor coverage.

A HetNet is a network consisting of infrastructure points with various wireless access technologies, each of them having different capabilities, constraints, and operating functionalities.

Different UEs might use different types of radio access technology (RAT) to access a wireless communications network. Some UEs, which can be referred to as multi-mode UEs, are capable of communicating using more than one RAT. For example, multi-mode UEs may include UEs that can obtain service from at least one mode of UMTS (Universal Mobile Telecommunications System), and one or more different systems such as GSM (Global System for Mobile Communications) bands or other radio systems. As defined herein, multi-mode UEs may be of any various type of multi-mode UE as defined or provided in 3GPP (3rd Generation Partnership Project), Technical Specification Group (TSG) Terminals, Multi-Mode UE Issues, Categories, Principles and Procedures (3G TR 21.910), which is incorporated herein by reference for all purposes. Some examples of RATs or of network technologies that might use different types of RATs include Universal Mobile Telecommunications System (UMTS) Terrestrial Radio Access Network (UTRAN), GSM, GSM EDGE Radio Access Network (GERAN), Wireless Fidelity (Wi Fi), General Packet Radio Service (GPRS), High-Speed Downlink Packet Access (HSDPA), High Speed Packet Access (HSPA), and long-term evolution (LTE). Other RATs or other network technologies based on these RATs may be familiar to one of skill in the art.

Device-to-Device (D2D) communication is a component of LTE and an underlay to the wireless communication network. It is necessary to establish synchronization between devices to perform D2D communication. The D2D communication in LTE focuses on Communication and Discovery aspects. In D2D communication, UEs can transmit data signals to each other over a direct link using PC5 link. In D2D communication when the Relay UE has a role of transmission, the Relay UE sends data and the Remote UE receives it. The Relay UE and Remote UE can change their transmission and reception role. The transmission from the Relay UE can be received by one or more UEs like Remote UE. This is illustrated in FIG. 2, bidirectional mode for PC5 link and UMTS to user (Uu) link.

A synchronization source is any node that transmits a Sidelink synchronization signal (SLSS). It can be either an eNB or a UE. When the synchronization source is eNB, the SLSS is the same as a 3GPP Release Dec. 13, 2014 primary synchronization signal (PSS) and secondary synchronization signal (SSS). D2D UE uses the synchronization signal to determine the timing for transmitting D2D signal. For the D2D SLSS, a D2D synchronization source transmits at least a D2D SLSS that may be used by a UE to obtain time and frequency synchronization.

Before transmitting the D2D synchronization signal, the D2D UE scans for available synchronization sources. If a synchronization source is detected, then the UE can synchronize its receiver to that source before it transmits the D2D synchronization signal. However, if a synchronization source is not detected, then a UE may still transmit the D2D synchronization signal. In this case, the UE may (re)select the D2D synchronization source it uses as the timing reference for its transmissions of the D2D synchronization signal, if the UE detects a change in the D2D synchronization sources, based on some criterions. Moreover, the Rel-12/13/14 Sidelink synchronization signal is designed for 6 PRBs bandwidth.

### SUMMARY OF THE INVENTION

One aim of the present disclosure is to provide an efficient method for reducing synchronization procedure and for performing selection and reselection of the synchronization source supporting 1 PRB limited bandwidth UEs (e.g. NB-IoT). Aspects of the present disclosure are to address at least the synchronization procedure for limited bandwidth UEs. It is necessary to establish synchronization between devices to perform D2D communications. Accordingly, an aspect of the present disclosure is to provide a method of supporting limited bandwidth UEs for synchronization communication.

The bandwidth capability of bandwidth limited UEs would not be the same as Rel-12/13/14 D2D because it requires a smaller bandwidth capability. In order to support the bandwidth capability of bandwidth limited UEs, the physical sideling discovery channel (PSDCH) should occupy 1 PRB per slot in a single subframe. The PSDCH payload therefore needs to be reduced to fit the proper PRB allocation.

A UE is expected to scan for synchronization sources before transmission of any sidelink signal. The synchronization procedure is time consuming, and even more so for 1 PRB bandwidth limited UEs that would also need to scan multiple frequency bands to detect the synchronization sources.

The Rel-12/13 synchronization procedure consists of the following steps:

1. In order to demodulate incoming D2D data, the receiver has to synchronize in time and frequency to the transmitter.

2. The synchronization procedure evaluates the coverage situation of the transmitting UE:
a. If both the UEs that are to take part in a D2D transmission are in-coverage of the same cell or of two synchronized cells, then synchronization is provided by eNBs.
b. If the UEs are in different non-synchronized cells or at least one UE is out-of-coverage, then it's a synchronization (e.g. random SLID) where some UEs will transmit synchronization signals

3. Selection of synchronization source:
a. A D2D UE becomes a synchronization source when it meets the criterion for Reference Signal Receive Power (RSRP) if in-coverage or synchronization threshold value if out-of-coverage.

4. Transmits the synchronization signal:
a. UE transmit the synchronization signals.

The previously proposed initial synchronization process as described above is rather time and energy consuming, especially for narrow band terminals that may need to scan multiple frequencies to detect synchronization reference even inside of the system bandwidth. Therefore additional synchronization enhancements may be considered to improve initial synchronization for devices operating with narrow bandwidth.

For 1 PRB bandwidth limited UEs, to reduce time consumption in the synchronization procedure, additional enhancement may be considered when determining the selection of the synchronization source for 1 PRB bandwidth limited UEs of type, e.g. eNB or UE. In this scenario, the limited BW UE (e.g. Remote UE) has both DL and SL reception capabilities, it can receive/transmit signals on Sidelink with the Relay UE and for the in-coverage limited BW UE (e.g. Remote UE) and it may also communicate with eNB on Uu downlink and uplink.

However, in one aspect of the present disclosure, for Sidelink communication, the limited BW UE (e.g. Remote UE) does not transmit SLSS/PSBCH. A synchronization source transmits a synchronization signal in which an in-coverage Relay UE serves as the synchronization source for the limited BW UE (e.g. Remote UE) as priority.

For this scenario and other scenarios (i.e. partial coverage and out-of-coverage), additional information could be provided for the initial acquisition synchronization procedure.

In an aspect of the present disclosure, instead of scanning multiple synchronization sources, the Remote UE may rely on a synchronization source group (SSG) selection/reselection that is configured to perform a pre-selection of synchronization sources for the initial acquisition that is based on the following criterion: type synchronization source, synchronization timing, and proximity to synchronization source. The limited bandwidth UEs may operate for this purpose only within a localized part of the frequency bandwidth transmission of SLSS. The Relay UE can then provide synchronization signals in the part of the bandwidth where the limited bandwidth UEs are assigned to communicate with Relay UE. The Remote UE that is attempting to receive synchronization would select a SSG in accordance with the criterion and select one of its synchronization sources.

The synchronization procedure for limited bandwidth UEs now proposed may comprise, or may consist essentially, of the following steps:

1. In order to demodulate the D2D data, the receiver has to synchronize in time and frequency to the transmitter.

2. SSG selection/reselection evaluation of initial acquisition based on the following criterion:
a. Type synchronization source;
b. Synchronization timing;
c. Proximity to synchronization source.

3. The synchronization acquisition to evaluate the coverage situation of the transmitting UE based on SSG.

4. Selection of synchronization source from SSG.

5. Transmits the synchronization signal (e.g. Relay UE).

6. Receives the synchronization signal (e.g. limited BW UE/Remote UE)

The D2D communication UE may be categorized, according to its role, into one of synchronization source UE (e.g. Relay UE) and synchronization destination UE (e.g. limited BW UE/Remote UE). The synchronization source is the UE that transmits a D2D synchronization signal. Depending on the case, the UE which transmits the DD synchronization signal may be treated as a Relay UE. The synchronization destination UE is the UE which received (but not transmits) the synchronization signal.

The SSG is responsible for the synchronization representative role of creating a group and may determine the synchronization timing independently. The whole synchronization procedure consists of a process of selection/reselection initial acquisition, transmission synchronization acquisition and role determination procedure after SSG selection for acquiring transmission synchronization and a process of reception synchronization acquisition after SSG selection for acquiring reception synchronization.

The Remote UE determines whether the current time is the timing of SSG for transmission at operation. The SSG selection/reselection may be performed to search for Relay UEs and eNBs. In the SSG process, the Remote UE first searches for an operating Relay UE. The Remote UE searches for an eNB only if no Relay UE is available. En the case of searching for Relay UEs, the operation of searching for eNBs may be omitted and the process may jump to the operation of searching for Relay UEs as priority. As a result of the SSG operation, the Remote UE detects at least one Relay UE synchronization signal (e.g. primary and secondary SLSS), then selects the synchronization signal of the at least one Relay UE to acquire synchronization with the Relay UE for operation. The operation of selecting one of the at least one Relay UE can be performed based on SSG initial acquisition and not the received signal power strength as specified in the legacy LTE standard. The procedure of becoming the Relay UE synchronization source is described below. After determining to become the Relay UE, the UE in question returns to the procedure for acquiring transmission synchronization. After finding the UE synchronization signal, then the Relay UE determines whether at least one SSG is detected at operation. If at least one SSG is detected, then it selects one of the at least one synchronization source to acquire synchronization.

The operation of selecting one of the at least one SSG may be performed based on at least one of the following:

1. Type synchronization source, and because the selecting Remote UE is a limited BW UE, start with Relay UE as priority.

2. Synchronization timing, synchronization validity duration.

3. Proximity to synchronization source, based on number of hops from limited BW UE.

### BRIEF DESCRIPTION OF THE DRAWINGS

Having thus described the invention in general terms, reference will now be made to the accompanying drawings, which are not necessarily drawn to scale, and wherein:

FIG. 1 is a diagram of a synchronization scanning process according to an embodiment of the disclosure.

FIG. 2 is diagram of the bidirectional mode for PC5 link and Uu link according to an embodiment of the disclosure.

FIG. 3 is diagram of a path switch from eNB link to Relay UE (in different cells) according to an embodiment of the disclosure.

FIG. 4 is diagram of a path switch from Relay UE to eNB link (in different cells) according to an embodiment of the disclosure.

FIG. 5 is diagram of a path switch from a Relay UE to another Relay UE (in different cells) according to an embodiment of the disclosure.

FIG. 6 is diagram of a Remote UE moves together with Relay UE according to an embodiment of the disclosure.

FIG. 7 is a flow diagram illustrating the user plane radio protocol for layer 2 evolved UE-to-Network relay (PC5).

FIG. 8 is a flow diagram illustrating the user plane radio protocol for layer 2 evolved UE-to-Network relay (non-3GPP access).

### DETAILED DESCRIPTION OF THE INVENTION

Referring to the drawings, embodiments are illustrated for the selection and reselection of a synchronization source that may make possible a reduction of the time in the synchronization procedure, with the selection and reselection of the synchronization source for 1 PRB bandwidth limited UEs (e.g. NB-IoT) in a wireless system, in which the synchronization source can be of type eNB or UE.

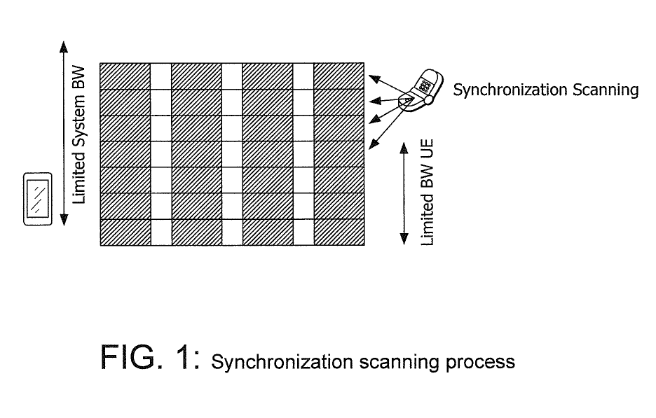

FIG. 1 illustrates a situation in which synchronization scanning might occur. The synchronization scanning process shows a Limited BW UE scanning to locate a Relay UE for synchronization with a source that may be an eNB or UE. The device shown as a Relay UE may in fact be the synchronization source, if there is no more authoritative source with which it can itself synchronize. If there is a more authoritative source, either an eNB or other base station or another UE, then the Relay UE relays synchronization commands from that source.

Because the Limited BW UE cannot survey as much bandwidth at once as a conventional UE, the Limited BW UE is obliged to scan from channel to channel, which becomes time consuming.

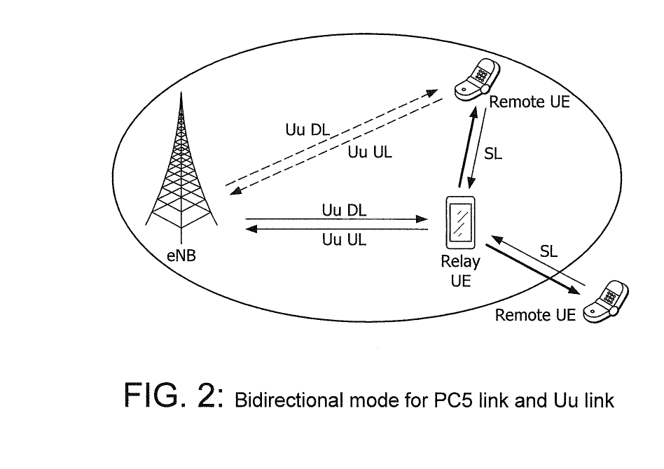

FIG. 2 illustrates a situation in which such a selection or reselection of the synchronization source might occur. The bidirectional mode for PC5 link and Uu link shows that a synchronization source can be an eNB or UE. As shown in solid lines in FIG. 2, the device marked as Relay UE can receive its synchronization signals directly by Uu download (DL) from the eNB or other base station, and the two Remote UEs can both receive their synchronization signals by sidelink (SL) from the Relay UE. However, as shown in dotted lines, one of the Remote UE's, which is within the coverage area of the eNB, can also receive synchronization signals by Uu DL directly from the eNB. If a Remote UE moves from one of those positions to the other, it may have occasion to reselect its synchronization source.

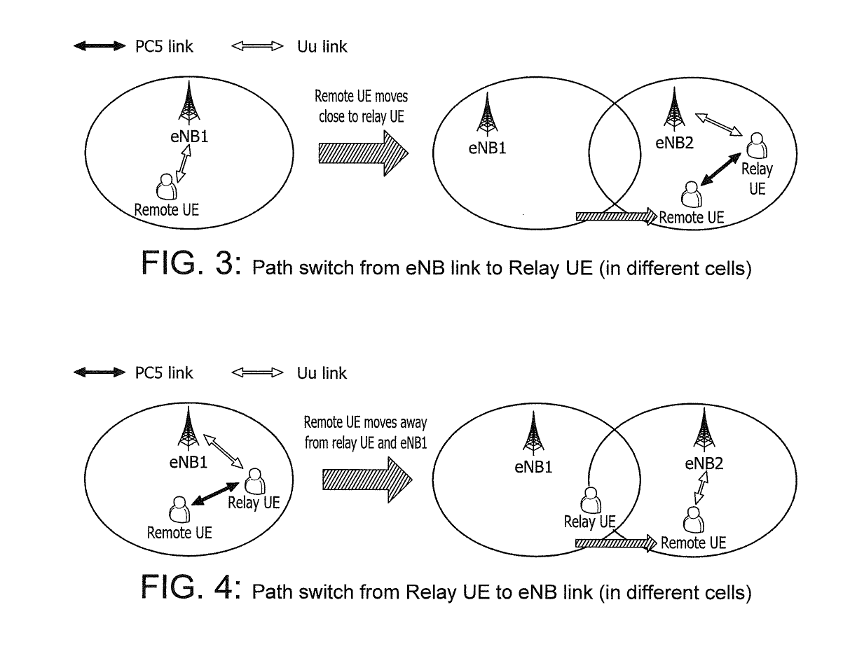

FIG. 3 illustrates another situation in which a selection or reselection of the synchronization source might occur. The Remote UE is initially in a first cell, where its source is a Uu link from eNB1. The Remote UE then moves from the first cell to a second cell, where the Remote UE is close to the Relay UE, which is itself synchronized over a Uu downlink by the eNB2. The Remote UE may then select a PC5 sidelink from the Relay UE as a new synchronization source.

FIG. 4 illustrates another situation in which a selection or reselection of the synchronization source might occur. The Remote UE was connected to the Relay UE, which was connected to eNB1 in a first cell, but the Remote UE moves away into a second cell, and switches path from Relay UE to eNB2 in the second cell.

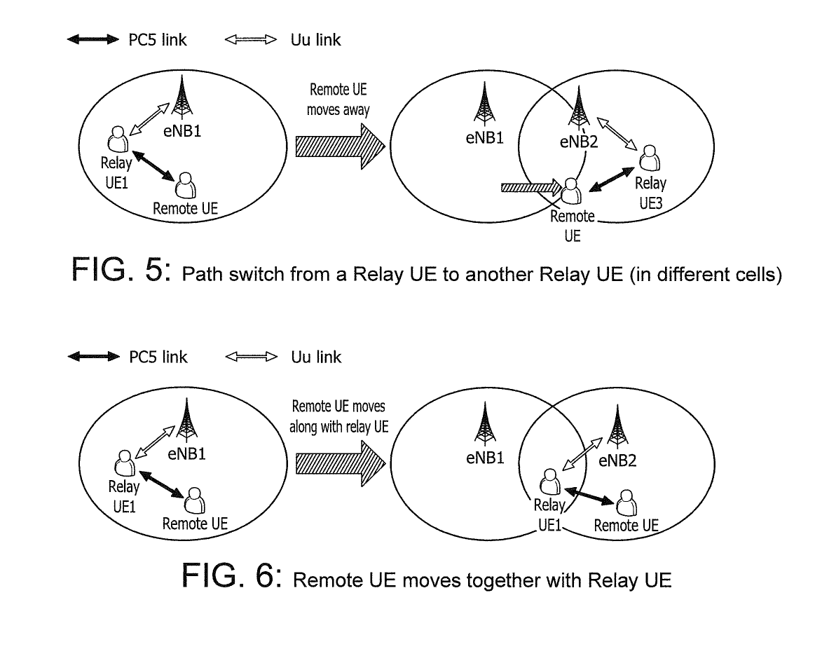

FIG. 5 illustrates another situation in which a selection or reselection of the synchronization source might occur. The Remote UE moves away in a path switch from Relay UE1, which is connected to eNB1 in a first cell, to Relay UE3, which is connected to eNB2 in a second cell.

FIG. 6 illustrates another situation in which a selection or reselection of the synchronization source might occur. Both the Remote UE and the Relay UE1 move from a first cell, where eNB1 is the synchronization source for Relay UE1, to a second cell, where eNB2 is the synchronization source for Relay UE1. Relay UE1 is the synchronization source for the Remote UE both before and after the move.

In all of the resynchronization embodiments illustrated in FIGS. 2 to 6, at least the remote UE may be a bandwidth limited (1 PRB) UE. As shown in FIG. 2, and for Relay UE, Relay UE1, and Relay UE3 in FIGS. 3-6, the limited BW UE (e.g. Remote UE) may have both DL and SL reception capabilities, so that the limited BW Remote UE can receive/transmit signals on Sidelink with the Relay UE and, when the Remote UE is in-coverage for an eNB, the Remote UE may also communicate directly with an eNB on Uu downlink and uplink.

For Sidelink communication, the limited BW UE (e.g. Remote UE) does not transmit SLSS/PSBCH. The eNB, Relay UE Relay UE1, or Relay UE3 transmits a synchronization signal. In an embodiment, even when the Remote UE is in-coverage for an eNB, the Relay UE serves as the synchronization source for the limited BW Remote UE, taking precedence over the eNB.

In an embodiment, additional information is provided for the initial acquisition synchronization procedure.

Instead of scanning multiple synchronization sources, the Remote UE shown in FIGS. 2-6 may rely on a synchronization source group (SSG) selection/reselection provided by the Relay UE (or by an eNB if that is the nearest apparent synchronization source) that is configured to perform a pre-selection of synchronization sources for the initial acquisition.

For the purpose of providing and receiving SSG information, the limited bandwidth UEs may operate only within a localized part of the frequency bandwidth transmission of SLSS, as shown in FIG. 1. The Relay UE may then be programmed to provide synchronization signals only in the part of the bandwidth where the limited bandwidth UEs are assigned to communicate with Relay UE. That economizes both on bandwidth occupied in transmitting the SSG information, and on time taken in locating the transmissions.

In an embodiment, the Remote UE that is attempting to receive synchronization selects a SSG in accordance with the criterion and select one of its synchronization sources.

In an embodiment, the synchronization procedure for limited bandwidth. UEs comprises, and may consist essentially of, the following steps:

1. In order to demodulate the D2D data, the receiver has to synchronize in time and frequency to the transmitter.

2. SSG selection/reselection and/or evaluation of initial acquisition, which may be prepared by the Relay UE and may be based on any or all of the following criteria:
a. Type synchronization source;
b. Synchronization timing and/or duration for which synchronization is valid;
c. Proximity to synchronization source, which may be measured in hops to an eNB or other ultimate source.

3. The synchronization acquisition to evaluate the coverage situation of the transmitting UE based on SSG.

4. Selection by the remote UE of a synchronization source from the SSG. Because the Relay UE, when it compiles the SSG list, cannot always know accurately the conditions at the Remote UE, the SSG preferably identifies several possible synchronization sources, and the Remote UE selects the first source that is of acceptable quality. It is thus not necessary for the remote UE to independently assess the signal quality or other attributes of every candidate source.

5. Relay UE transmits the synchronization signal.

6. Remote UE (e.g. limited BW UE) receives the synchronization signal.

7. Exchange of data traffic commences.

In the interests of simplicity, the synchronization process has been described above by reference to the “Remote UE” as a synchronization destination, and a “Relay UE” as a synchronization source. The same process may be used when the Remote UE connects directly to eNB, eNB1, eNB2, or other base station as a synchronization source. The same process may be used with “Relay UE,” “Relay UE1,” or “Relay UE3” as the synchronization destination, and eNB, eNB1, eNB2, or other base station as the synchronization source. The same process may be used in a multi-hop embodiment, in which both the synchronization source and the synchronization destination become relay UEs between an ultimate source (which may be an eNB) and an ultimate destination remote UE. In FIGS. 2-6, the ultimate synchronization source is an eNB, but, especially if there is no base station within range of any of the UEs, one of the UEs may appoint itself as the ultimate synchronization source.

When data traffic is being exchanged, any relay UE may be a source, a destination, or a relay for data traffic to and from a remote UE, independently of whether that relay UE is a source or a relay for synchronization signals to that remote UE.

The UE engaged in D2D communication may be categorized, according to its role, into one of synchronization source UE (e.g. Relay UE) and synchronization destination UE (e.g. limited BW UE/Remote UE). The synchronization source is the UE that transmits a D2D synchronization signal. Depending on the case, the UE that transmits the D2D synchronization signal may be treated as a Relay UE. The synchronization destination UE is the UE which receives (but not transmits) the synchronization signal.

The SSG is responsible for the synchronization representative role of creating a group and may determine the synchronization timing independently. The whole synchronization procedure consists of a process of selection/reselection initial acquisition, transmission synchronization acquisition and role determination procedure after SSG selection for acquiring transmission synchronization and a process of reception synchronization acquisition after SSG selection for acquiring reception synchronization.

The Remote UE determines whether the current time is the timing of SSG for transmission at operation. The SSG selection/reselection may be performed to search for Relay UEs and eNBs. In the SSG process, the Remote UE first searches for an operating Relay UE. In an embodiment, the Remote UE searches for an eNB only if no Relay UE is available. In the case of searching for Relay UEs, the operation of searching for eNBs may be omitted and the process may jump to the operation of searching for Relay UEs as priority. As a result of the SSG operation, the Remote UE detects at least one Relay UE synchronization signal (e.g. primary and secondary SLSS), then selects the synchronization signal of the at least one Relay UE to acquire synchronization with the Relay UE for operation. The operation of selecting one of the at least one Relay UE can be performed based on SSG initial acquisition and not the received signal power strength as specified in the legacy LTE standard. After determining to become the Relay UE, the UE in question returns to the procedure for acquiring transmission synchronization. After finding the UE synchronization signal, then the Relay UE determines whether at least one SSG is detected at operation. If at least one SSG is detected, then it selects one of the at least one synchronization source to acquire synchronization.

The operation of selecting one of the at least one SSG may be performed based on at least one of the following:

1. Type synchronization source, and because the selecting Remote UE is a limited BW UE, start with Relay UE as priority.

2. Synchronization timing, synchronization validity duration.

3. Proximity to synchronization source, based on number of hops from limited BW UE.

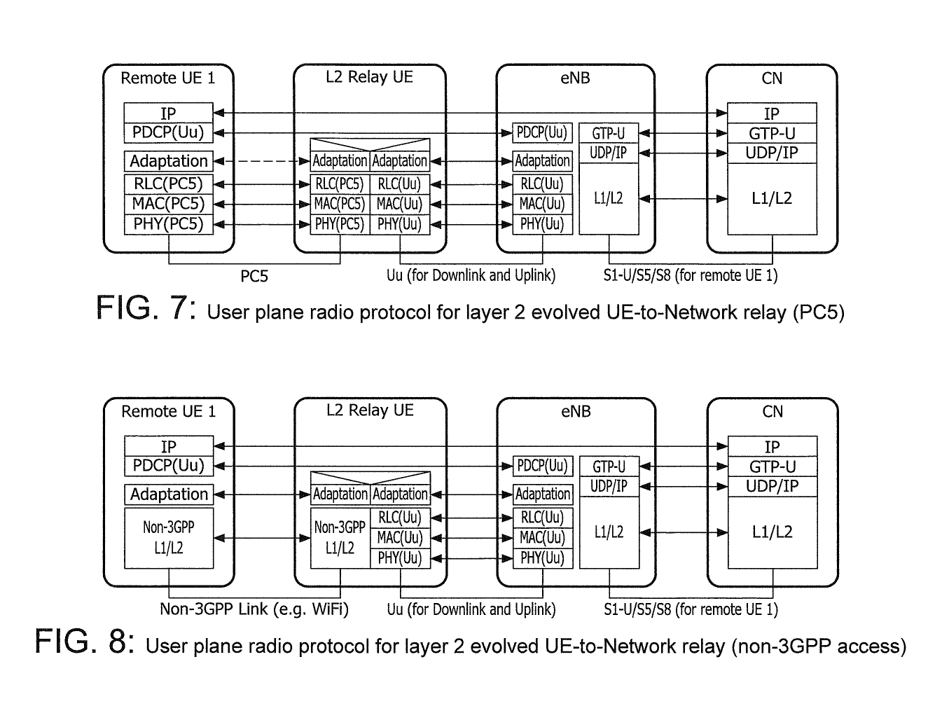

FIG. 7 is a flow diagram illustrating the user plane radio protocol for layer 2 evolved UE-to-Network relay (PC5).

FIG. 8 is a flow diagram illustrating the user plane radio protocol for layer 2 evolved UE-to-Network relay (non-3GPP access).

In an embodiment, For the SLSS there are primary sidelink synchronization signals (PSSS) and secondary sidelink synchronization signals (SSSS) and the MIB-SL is transmitted over the SL-BCH. For sidelink communication there is an SLSS and the MIB-SL message (the MIB-SL message includes sl-bandwidth for transmission bandwidth configuration that corresponds to resource blocks, inCoverage flag, etc.). For Sidelink discovery, the synchronization information involves only an SLSS, except in the case of the public safety (PS) related discovery, where some additional configuration parameters would be necessary (E.g. the MIB-SL message would be necessary).

In and embodiment, the synchronization receiving UE would select a synchronization source from the synchronization source group (SSG) in accordance with the criterion. In general, one criterion is that the Remote UE can be configured to receive the SLSS from the Relay UE.

The D2D direct interface is typically ProSe (PC5) which is a protocol interface. Once a group has been identified, the UE then uses criterion inputs to prepare the Remote UE towards selecting the most likely candidate from the SSG.

In an embodiment, if the Remote UE detects two different candidate relay UEs offering different SSG lists, the Remote UE will select one of the most likely candidate synchronization sources.

1. A method of choosing a synchronization source for a wireless remote user equipment, comprising:
establishing a synchronization source group of devices each of which is capable of acting as a source of synchronization signals;
establishing an order of the devices within the synchronization source group;
determining for only a selected one of the devices in the order, whether that one of the devices is able to serve as a source of synchronization signals to the remote user equipment;
if the selected device is able to serve, choosing the selected device as the synchronization source;
if the selected device is not able to serve, repeating the determining and choosing steps and this step until one of the devices that is able to serve is chosen, or until all devices within the synchronization source group are determined to be unable to serve;
wherein the devices are selected in the established order.

2. The method of claim 1, wherein the establishing steps are carried out by one of the devices of the synchronization source group, and the determining and choosing are carried out by the remote user equipment.

3. The method of claim 2, further comprising said one of the devices transmitting the synchronization source group and the established order to the remote user equipment.

4. The method of claim 2, wherein said one of the devices is a relay user equipment that receives the synchronization signals from another device.

5. The method of claim 1, wherein determining whether the selected device is able to serve comprises making a measurement of signal quality for wireless transmissions between the selected device and the remote user equipment.

6. The method of claim 1, wherein the synchronization source group and the established order are transmitted only within a localized part of a frequency bandwidth transmission available for sidelink synchronization signals, and the remote user equipment is operative to attempt to detect transmissions of the synchronization source group only within said localized part.

7. The method of claim 1, wherein establishing the synchronization source group comprises assessing one or more of:
a type of synchronization source;
a synchronization timing;
a duration of synchronization validity;
a proximity to a synchronization source.

8. The method of claim 7, wherein proximity to the synchronization source is measured in number of hops.

9. The method of claim 1, wherein relay user equipment are before base stations in the established order

10. A user equipment operative to choose a synchronization source for a wireless remote user equipment, the user equipment being operative to:
receive a synchronization source group of devices each of which is capable of acting as a source of synchronization signals and an order of the devices within the synchronization source group;
determine for only a selected one of the devices in the order, whether that one of the devices is able to serve as a source of synchronization signals to the remote user equipment;
if the selected device is able to serve, choose the selected device as the synchronization source; and
if the selected device is not able to serve, select a next device and repeat the determining and choosing steps and this step until one of the devices that is able to serve is chosen, or until all devices within the synchronization source group are determined to be unable to serve;
wherein the devices are selected in the established order.

11. The user equipment of claim 10, further operative to receive the synchronization source group and the established order from one of the devices in the synchronization source group.

12. The user equipment of claim 10, further operative in determining whether the selected device is able to serve to make a measurement of signal quality for wireless transmissions between the selected device and the remote user equipment.

13. The user equipment of claim 10, further operative to attempt to detect transmissions of the synchronization source group and the established order are transmitted only within a localized part of a frequency bandwidth transmission available for sidelink synchronization signals.

14. A device for providing a synchronization source for a wireless remote user equipment, said device operative to:
establish a synchronization source group of devices each of which is capable of acting as a source of synchronization signals; and
establish an order of the devices within the synchronization source group.

15. The device of claim 14, which is one of the devices of the synchronization source group.

16. The device of claim 15, further operative to transmit the synchronization source group and the established order to the remote user equipment.

17. The device of claim 14, which is a relay user equipment that receives the synchronization signals from another device.

18. The device of claim 14, further operative to transmit the synchronization source group and the established order only within a localized part of a frequency bandwidth transmission available for sidelink synchronization signals.

19. The device of claim 14, further operative in establishing the synchronization source group to assess one or more of:
a type of synchronization source;
a synchronization timing;
a duration of synchronization validity;
a proximity to a synchronization source.

20. The device of claim 14, further operative to place relay user equipment before base stations in establishing the order
